(19) United States
(12) Patent Application Publication
(10) Pub. No.: US 2015/0358892 A1
(43) Pub. Date: Dec. 10, 2015

(54) SSID-BASED ADVERTISING OF SERVICES

(71) Applicant: Cisco Technology, Inc., San Jose, CA (US)

(72) Inventors: Santosh Pandey, Newark, CA (US); Jagdish Girimaji, Pleasanton, CA (US); Neil R. Diener, Hudson, OH (US); Brian D. Hart, Sunnyvale, CA (US)

(21) Appl. No.: 14/296,928

(22) Filed: Jun. 5, 2014

(51) Int. Cl. H04W 48/10; H04W 4/02; H04W 48/14; H04W 4/20

(52) U.S. Cl. CPC H04W 48/10; H04W 4/206; H04W 4/02; H04W 48/14

(57) ABSTRACT

A wireless access point uses broadcast Service Set Identifiers (SSIDs) to advertise services available to a user device within range of the access point. The access point receives information about a first service available from a first service provider, and generates a first SSID associated with the first service. The access point receives information about a second service available from a second service provider, and generates a second SSID associated with the second service. The access point broadcasts the first SSID during a first period of time in a wireless network, and broadcasts the second SSID in the wireless network during a second period of time that is non-overlapping with the first period of time.

### TECHNICAL FIELD

The present disclosure relates to providing third party services to wireless devices and their users.

### BACKGROUND

Service Set Identifiers (SSIDs) are used in wireless networks to advertise the presence of the wireless network to user devices. Typically, the SSID is used as the name of the wireless network, and the name may provide an indication to the user of the type and/or owner of the wireless network. For example, an SSID of “Public” would generally be used to advertise a publicly available network, and an SSID of “Alice's House” would indicate a private network for which a user may be required to supply a password from Alice to access the network.

### BRIEF DESCRIPTION OF THE DRAWINGS

FIG. 1 is a block diagram of a system of wireless network access points configured to provide services to a wireless user device according to an example embodiment.

FIG. 2 is a block diagram of a user device configured to detect and process SSIDs according to an example embodiment.

FIG. 3 is a block diagram of an access point configured to generate and broadcast SSIDs according to an example embodiment.

FIG. 4A is a representation of the parts of an SSID according to an example embodiment.

FIG. 4B is a timing diagram depicting wireless network management frames in which multiple SSIDs are broadcast according to an example embodiment.

FIG. 5 is a block diagram showing the message flow in advertising and providing a service to a user device according to an example embodiment.

FIG. 6 is a flowchart depicting operations of an access point in advertising services according to an example embodiment.

FIG. 7 is a flowchart depicting operations of a user device in alerting a user to services that are advertised according to an example embodiment.

### DESCRIPTION OF EXAMPLE EMBODIMENTS

### Overview

An access point uses broadcast SSIDs to advertise services available to a user device within range of the access point. The access point receives information about a first service available from a first service provider, and generates a first SSID associated with the first service. The access point receives information about a second service available from a second service provider, and generates a second SSID associated with the second service. The access point broadcasts the first SSID during a first period of time in a wireless network, and broadcasts the second SSID in the wireless network during a second period of time that is non-overlapping with the first period of time.

### Example Embodiments

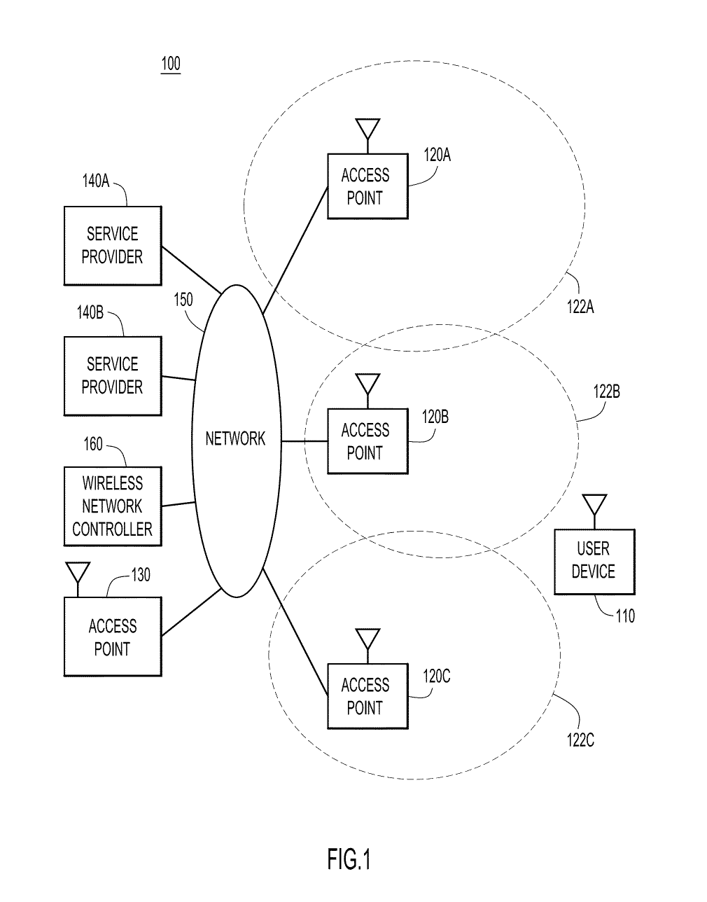

Referring to FIG. 1, a system 100 is shown that enables a user device 110 to access services (e.g., location-based services) based on low power Wi-Fi™ (e.g. IEEE 802.11) wireless local area network access points. Access points 120A, 120B, and 120C have ranges depicted at regions denoted by reference numerals 122A, 122B, and 122C, respectively. Access point 130 does not have a depicted range, and may be able to connect to the user device 110 over a significantly larger area than any of the access points 120A, 120B, or 120C. Service providers 140A and 140B are coupled to access points 120A, 120B, 120C, and 130 through network 150, which allows the access points to advertise the services provided to the user device 110. A wireless network controller 160 may be provided that communicates by network 150 to the access points 120A, 120B, 120C and 130. The service providers 140A and 140B may communicate with the access points via the wireless network controller 160.

In one example, the difference between access points 120A, 120B, and 120C may be a difference in configuration, with each of the access points being configurable with a range and function similar to the other access points. In one example, access points 120A, 120B and 120C may broadcast a Service Set Identifier (SSID) for a wireless local area (e.g., Wi-Fi™) network, but may or may not have the capability to set up the wireless network. In order to conserve power, the access points 120A, 120B and 120C may advertise an available service by broadcasting the SSID for a wireless network, and require the user device 110 to receive the service through a separate network wireless connection, e.g., via access point 130. In one example, service providers 140A and 140B may provide services such as location-based advertising, promotional offers, customized user directions, proximity alerts, etc.

Only four access points and two service providers are shown in FIG. 1, but any number of access points and/or service providers may be included in system 100. Additionally, any number of user devices similar to user device 110 may be included in system 100.

The user device 110 may take a variety of forms, including a desktop computer, laptop computer, mobile/cellular phone, tablet computer, Internet telephone, etc. In one example, the access points may take the form of a low-energy wireless local area network (e.g., Wi-Fi) access point with an adjustable range , e.g., an adjustable broadcast power. In one example, the shape of the coverage area may be adjustable, in addition or instead of just the range of the coverage area being adjustable.

Access point 130 may take a variety of forms including a cellular tower or a full power wireless local area network (Wi-Fi) access point. Additionally, service providers 140A and 140B may take a variety of forms, including one or more desktop computers, servers, laptop computers, mobile/cellular phones, tablet computers, etc. Network 150 may be any type of network (e.g., any combination of Internet, intranet, local area network (LAN), wide area network (WAN), wired network, wireless network, etc.) that connects computing devices, e.g., service providers 140 with user devices 110 through access points 120 and/or 130.

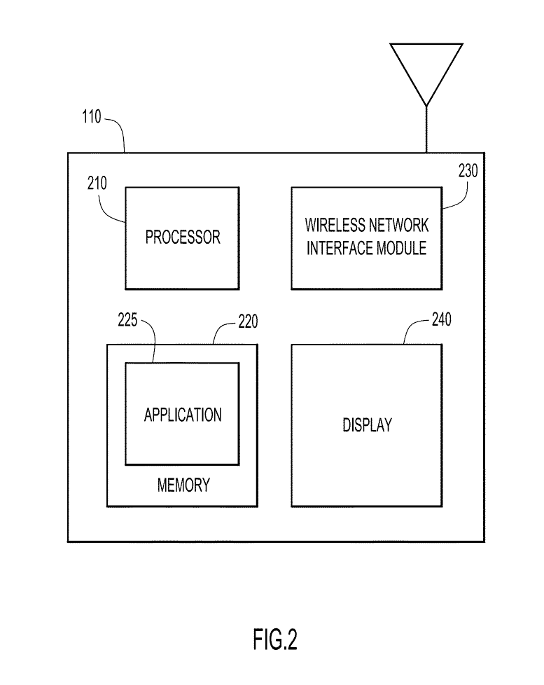

Referring now to FIG. 2, a simplified block diagram of a user device 110 configured to use the services of a service provider 140A is shown. User device 110 includes, among other possible components, a processor 210 to process instructions relevant to receiving a service, and a memory 220 to store a variety of data and software instructions (e.g., application 225). The user device 110 also includes a wireless network interface module 230 to communicate with access points 120 and/or access point 130. The user device 110 may also include a display 240 to show a user an indication of the services available, as well as other functions of the user device 110.

Memory 220 may comprise read only memory (ROM), random access memory (RAM), magnetic disk storage media devices, optical storage media devices, flash memory devices, electrical, optical, or other physical/tangible (e.g., non-transitory) memory storage devices. The processor 210 is, for example, a microprocessor or microcontroller that executes instructions for implementing the processes described herein. Thus, in general, the memory 220 may comprise one or more tangible (non-transitory) computer readable storage media (e.g., a memory device) encoded with software comprising computer executable instructions and when the software is executed (by the processor 210) it is operable to perform the operations described herein.

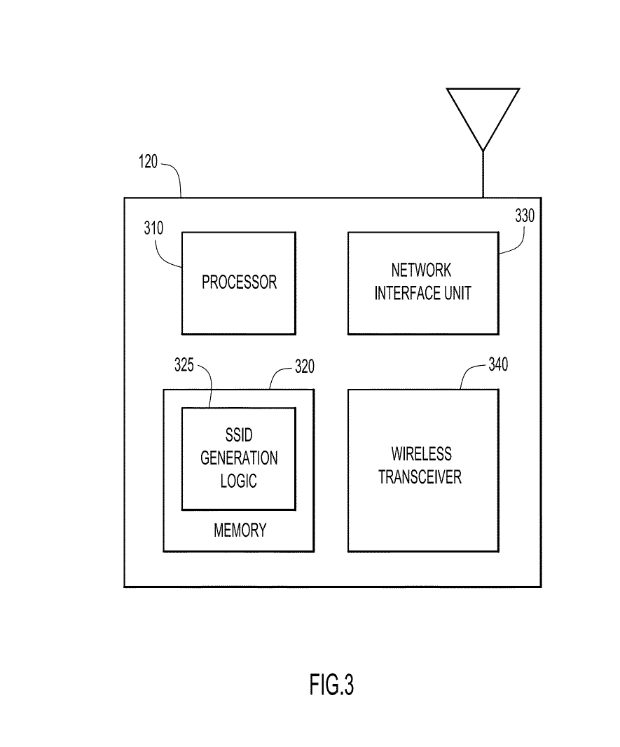

Referring now to FIG. 3, a simplified block diagram of an access point 120 configured to advertise services is shown. Access point 120 includes, among other possible components, a processor 310 to process instructions relevant to advertising a service through a broadcast SSID, and a memory 320 to store a variety of data and software instructions (e.g., SSID generation logic 325). The access point 120 also includes a network interface unit (e.g., network interface card) 330 to communicate with other computing devices, e.g., service providers 140, over network 150. The access point includes a wireless transceiver 340 to send and receive messages in a wireless network, e.g., broadcasting an SSID to advertise a Wi-Fi network and/or communicating with user device 110.

Memory 320 may comprise ROM, RAM, magnetic disk storage media devices, optical storage media devices, flash memory devices, electrical, optical, or other physical/tangible (e.g., non-transitory) memory storage devices. The processor 310 is, for example, one or more microprocessors or microcontrollers that execute instructions for implementing the processes described herein with respect to a plurality of virtual machines. Thus, in general, the memory 320 may comprise one or more tangible (non-transitory) computer readable storage media (e.g., a memory device) encoded with software comprising computer executable instructions and when the software is executed (by the processor 310) it is operable to perform the operations described herein.

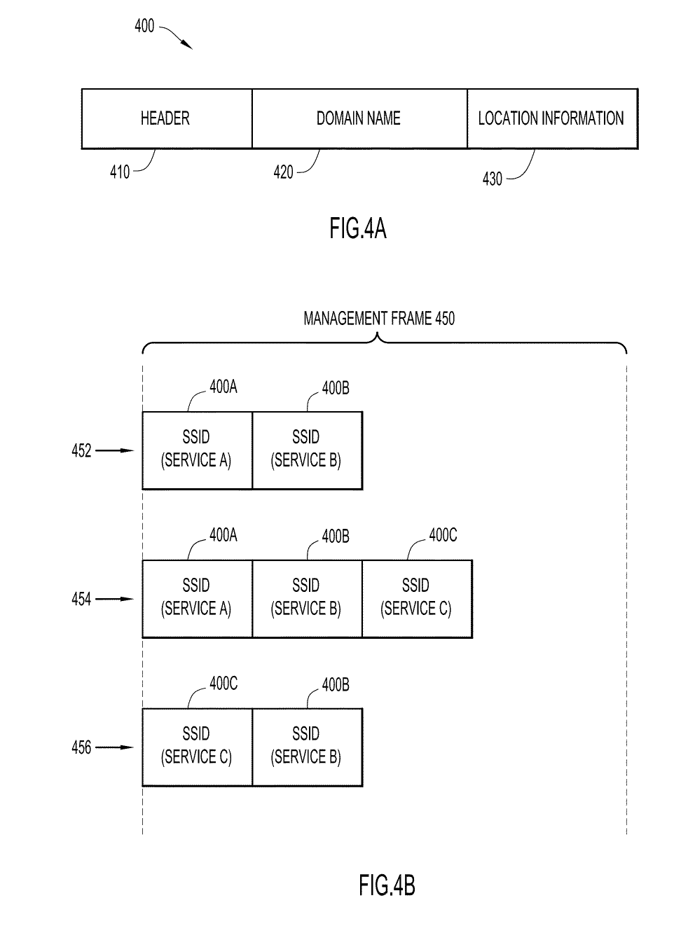

Referring now to FIG. 4A, an example of an SSID used to advertise a service is shown. According to the IEEE 802.11 standard, an SSID comprises thirty-two octets/bytes, with each octet capable of taking a value from 0-255. In the example of FIG. 4A, the thirty-two octets of SSID 400 are reserved for a header portion 410, a domain name portion 420, and a location portion 430. In one example, three bytes are reserved for the header portion 410 to signal application 225 (running in user device 110, as shown in FIG. 2) that the SSID is being used to advertise a service. The header portion 410 may comprise specific characters, e.g., “˜”, that place the SSID 400 lower on the list of available SSIDs visible to the user.

In one example, twenty-five bytes of the SSID 400 are reserved for the domain name portion 420. The domain name portion 420 may comprise a domain name at which the user device 110 can contact the service provider 140. In one example, the domain name portion 410 may comprise a hashed version of a domain name that can be redirected to the full domain name of the service provider 140. In an example, four bytes of the SSID 400 are reserved for the location information portion 430. The location information portion 430 comprises information that allows the user device 110 to specify the physical location of the user device 110 when it contacts the service provider 140 at the domain name specified in the domain name portion 420.

In one example, the location information portion 430 may comprise the Media Access Control (MAC) address of the access point that is broadcasting the SSID 400. The MAC address of the access point identifies the particular access point, which may be associated with a specific physical position. When the user device 110 contacts the service provider and identifies the MAC address of the access point that provided the domain name, the service provider may determine that the user device 110 is in the general proximity of the physical position associated with the identified access point. Once the service provider has determined the approximate physical position of the user device 110, the service provider can provide location-based services to the user device 110. The accuracy of the determined physical position of the user device 110 may be adjusted by adjusting the range of the access point.

In another example, the operating system of the user device 110 may pass the SSID 400 to any or all applications on the user device 110. In this example, any application that can identify that SSID, e.g., through the header portion 410, may be able to contact the service provider at the domain name from the domain name portion 420.

In yet another example, a hash of the SSID 400 may be included instead of (or in addition to) the location portion 430 as part of the domain name portion 420. This gives the user device information on a separate SSID that may be used to access the service advertised with SSID 400.

In a further example, the message advertising the offered service may use a vendor-proprietary or non-proprietary data element type or format.

Referring now to FIG. 4B, three examples of management frames 450 are shown that use broadcast SSIDs to advertise services that are offered. A management frame 450 is typically reserved in a wireless network protocol to advertise the various networks that may be available from a particular access point. Within the management frame 452, an access point has been configured to advertise two services: service A and service B. The access point generates an SSID 400A encoded with the information needed for a user device to receive the service A, e.g., header, domain name, and location information. The access point also generates an SSID 400B encoded with the information needed for a user device to receive the service B. As long as the access point is instructed to advertise both service A and service B, the access point will repeatedly broadcast the management frame 452 comprising SSID 400A and SSID 400B at the interval defined in the wireless network protocol. In another example, the access point may advertise services at a user specified interval, which may be different for service A and service B. As a specific example, the access point may broadcast SSID 400A twice as frequently as SSID 400B, causing service A to be advertised twice as much as service B.

In one example, a third service, e.g., service C, becomes available from the access point, while service A and service B are also available. In this example, the access point will generate an SSID 400C encoded with the information needed for a user device to receive the service C. The access point will then start broadcasting management frame 454 comprising SSID 400A, SSID 400B, and SSID 400C.

In still another example, the access point may be instructed to remove the advertisement of service A, and add the advertisement of service C. In this example, the access point will start to broadcast the management frame 456 comprising SSID 400C and SSID 400B. Though the SSIDs 400A, 400B, and 400C are depicted at the beginning of the management frame, in other examples, the SSIDs may be broadcast in any time slot that does not overlap with another SSID.

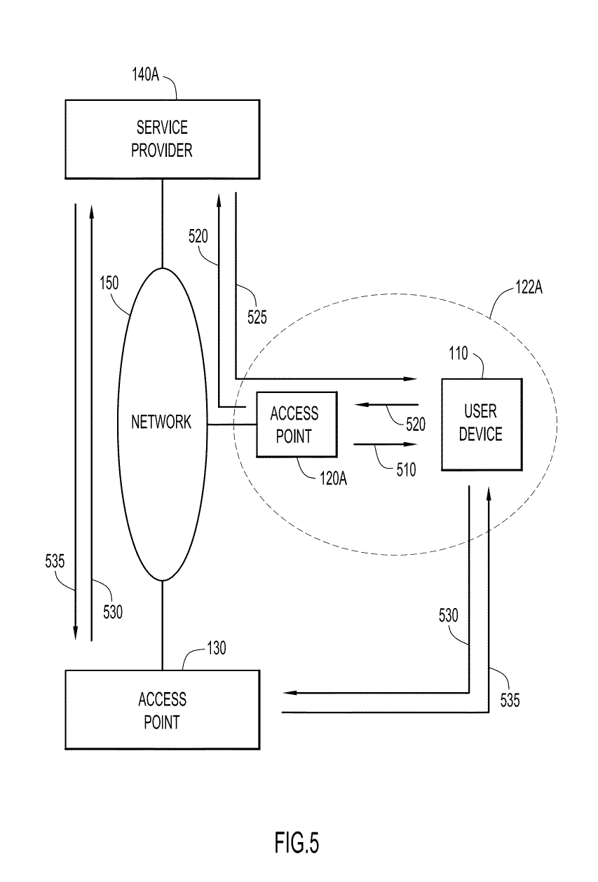

Referring now to FIG. 5, a simplified flow diagram shows an example of messages passed while advertising and providing a service to user device 110. Access point 120A and service provider 140A are referred to, as an example, in FIG. 5. In message 510, access point 120A broadcasts an SSID formatted to advertise a service offered by service provider 140A. When user device 110 comes within range 122A of the access point 120A, the user device 110 receives the message 510. In response to the user selecting to receive the offered service, the user device may send a message 520 to the service provider 140A through the access point 120A and network 150. The service provider 140A may then provide the offered service through one or messages 525. Alternatively, after receiving the SSID in message 510, the user device 110 may send a message 530 to the service provider 140A through a different access point, e.g., access point 130. The service provider 140A may respond to provide the service with one or messages 535 through access point 130. In other examples, the request for the service may travel via access point 120A while the service is provided via access point 130, or the request for the service may travel via access point 130 while the service is provided via access point 120A.

In one example, the access point may select a channel in a wireless (e.g., Wi-Fi) network to advertise services. The access point may minimize co-channel interference by avoiding a channel with a strong signal that another access point is using. To provide location-based services the access point may limit the transmit power such that the service advertisements reach up to a maximum range (e.g., 10 feet). In a specific example, these advertising beacons may be transmitted at 100 millisecond intervals at 54 Mbps.

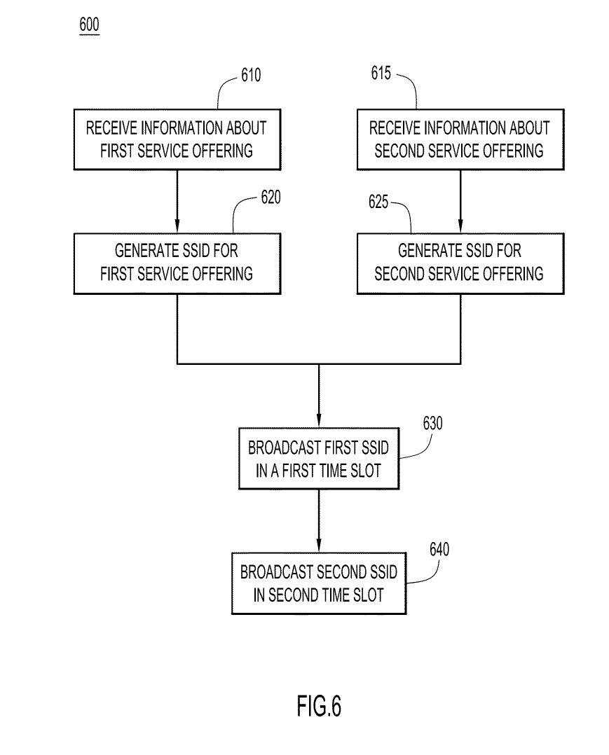

Referring now to FIG. 6, an example process 600 performed by an access point for advertising services according to the techniques presented is shown. In step 610, the access point receives information about a first service offered by a service provider. In step 615, the access point receives information about a second service offered by a service provider. The access point generates a first SSID associated with the first service at step 620. The access point also generates a second SSID associates with the second service at step 625. The access point broadcasts the first SSID in a first time slot in step 630, and, in step 640, the access point broadcasts the second SSID in a second time slot that does not overlap the first time slot. In one example, the first and second SSIDs comprise a header portion, a domain name portion, and location information. The location information may comprise an identifier, e.g., the MAC address, of the access point to which the user device is associated and/or from which it received the SSID, which may be associated with a specific geographic location.

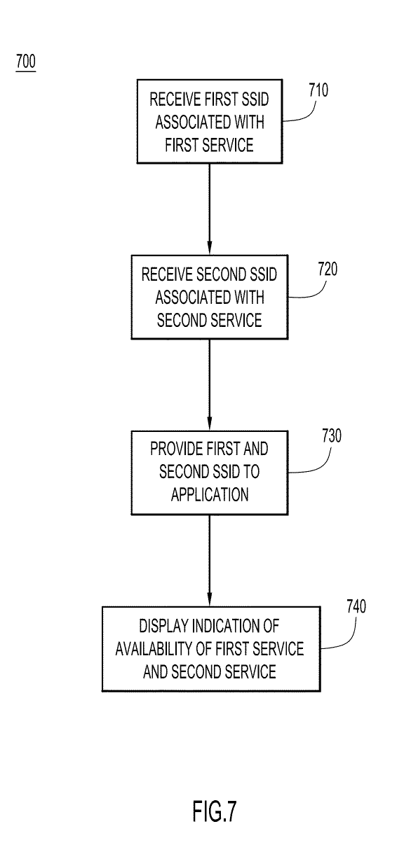

Referring now to FIG. 7, an example process 700 performed by a user device in order to display an offered service to a user is shown. In step 710, the user device receives a first SSID associated with a first service. In step 720, the user device receives a second SSID associated with a second service. The user device provides the first and second SSIDs to an application running on the user device in step 730. In step 740, the user device displays an indication that informs the user of the availability of the first service and displays an indication of the availability of the second service.

In summary, the techniques presented herein provide for using low power Wi-Fi tags/access points as beacon emitters for proximity detection in addition to advertising and delivering location-based services. An existing Wi-Fi infrastructure/backhaul may be used for management and monitoring of the tags. By using the SSID, which is typically passed to any application, for advertising services, any application may be able to use the service, rather than requiring a specific application to run in the background and intercept a service advertised in other forms (e.g., as a Bluetooth message).

In one example, the techniques presented herein provide for a method for wireless access point to use broadcast SSIDs to advertise services available to a user device within range of the access point. The access point receives information about a first service available from a first service provider, and generates a first SSID associated with the first service. The access point receives information about a second service available from a second service provider, and generates a second SSID associated with the second service. The access point broadcasts the first SSID during a first period of time in a wireless network, and broadcasts the second SSID in the wireless network during a second period of time that is non-overlapping with the first period of time.

In another example, an apparatus is provided comprising a network interface unit, a processor, and a wireless transceiver. The network interface unit is configured to enable communications over a network. The processor is configured to obtain from one or more messages received via the network interface unit information about a first service available from a first service provider and information about a second service available from a second service provider; generate a first Service Set Identifier (SSID) associated with the first service; generate a second SSID associated with the second service. The wireless transceiver is configured to broadcast the first SSID during a first period of time in a wireless network, and broadcast the second SSID during a second period of time in the wireless network. The processor also causes the first period of time and the second period of time to be non-overlapping.

In yet another example, a computer-implemented method is provided for a user device to receive advertisements for services and display the advertisement of services to a user. The user device receives from a wireless access point, a first SSID associated with a first service. The user device also receives from the wireless access point, a second SSID associated with a second service. The first SSID and the second SSID are provided to at least one application running on the user device. The user device displays a first indication of availability for the first service, and displays a second indication of availability for the second service.

The above description is intended by way of example only. Various modifications and structural changes may be made therein without departing from the scope of the concepts described herein and within the scope and range of equivalents of the claims.

What is claimed is:

1. A method comprising:
receiving information about a first service available from a first service provider;
generating a first Service Set Identifier (SSID) associated with the first service;
receiving information about a second service available from a second service provider;
generating a second SSID associated with the second service;
broadcasting from a wireless access point the first SSID during a first period of time in a wireless network; and
broadcasting from the wireless access point the second SSID in the wireless network during a second period of time that is non-overlapping with the first period of time.

2. The method of claim 1, further comprising generating a third SSID associated with a third service and broadcasting the third SSID in the wireless network in a third period of time that is non-overlapping with the first period of time and the second period of time.

3. The method of claim 1, further comprising generating a third SSID associated with a third service and broadcasting the third SSID in the wireless network in the first period of time in place of the first SSID.

4. The method of claim 1, wherein the first SSID and the second SSID each conform to a standard for advertising in a wireless network.

5. The method of claim 1, wherein the first SSID comprises a location identifier segment that enables the first service to provide a location-based service.

6. The method of claim 5, wherein the location-based service comprises one of or more of:
advertising, providing user directions, offering promotional discounts, and providing proximity alerts.

7. The method of claim 5, further comprising adjusting a power for at least the broadcasting of the first SSID to adjust a range associated with the location-based service.

8. The method of claim 1, further comprising:
receiving from a user device, a user request for the first service;
forwarding the user request to the first service provider;
receiving from the first service provider, data enabling the first service; and
wirelessly transmitting the data enabling the first service to the user device.

9. An apparatus comprising:
a network interface unit configured to enable communications over a network;
a processor coupled to the network interface unit, and configured to:
obtain from one or more messages received via the network interface unit information about a first service available from a first service provider and information about a second service available from a second service provider;
generate a first Service Set Identifier (SSID) associated with the first service;
generate a second SSID associated with the second service; and
a wireless transceiver configured to:
broadcast the first SSID during a first period of time in a wireless network; and
broadcast the second SSID during a second period of time in the wireless network;
wherein the processor is further configured to cause the first period of time and the second period of time to be non-overlapping.

10. The apparatus of claim 9, wherein the processor is further configured to generate a third SSID associated with a third service, and cause the wireless transceiver to broadcast the third SSID in the wireless network in a third period of time that is non-overlapping with the first period of time and the second period of time.

11. The apparatus of claim 9, wherein the processor is further configured to generate a third SSID associated with a third service, and cause the wireless transceiver to broadcast the third SSID in the wireless network in the first period of time in place of the first SSID.

12. The apparatus of claim 9, wherein the wireless transceiver is further configured to receive from a user device, a user request for the first service, and transmit data enabling the first service to the user device; and wherein the network interface unit is further configured to forward the user request to the first service provider, and receive from the first service provider, the data enabling the first service.

13. The apparatus of claim 9, wherein the first SSID comprises a location identifier segment that enables the first service to provide a location-based service.

14. The apparatus of claim 13, wherein the processor is further configured to adjust a power of the wireless transceiver such that a range associated with the location-based service is adjusted.

15. A method comprising:
receiving at a wireless device from a wireless access point, a first Service Set Identifier (SSID) associated with a first service;
receiving from the wireless access point, a second SSID associated with a second service;
providing the first SSID and the second SSID to at least one application running on the wireless device;
displaying on the wireless device a first indication of availability for the first service; and
displaying on the wireless device a second indication of availability for the second service.

16. The method of claim 15, further comprising:
receiving a user request for the first service;
transmitting a request for the first service; and
receiving data enabling the first service.

17. The method of claim 16, wherein the request for the first service is transmitted to the wireless access point.

18. The method of claim 15, wherein the first SSID and the second SSID each conform to a wireless standard for advertising a wireless network.

19. The method of claim 15, wherein the first SSID and the second SSID are received during non-overlapping periods of time.

20. The method of claim 15, wherein the first service comprises a location-based service and the first SSID comprises a location identifier associated with the wireless access point.
